(19) United States
(12) Patent Application Publication
(10) Pub. No.: US 2012/0066158 A1
(43) Pub. Date: Mar. 15, 2012

(54) THEFT PROTECTION DURING THE SECURITY CHECK OF CARRY-ON LUGGAGE

(75) Inventors: Joern Bruett, Nuernberg (DE); Ingolf Rauh, Reichenau (DE); Wolf-Stephan Wilke, Konstanz (DE)

(73) Assignee: SIEMENS AKTIENGESELLSCHAFT, Muenchen (DE)

(21) Appl. No.: 13/322,239

(22) PCT Filed: May 25, 2010
(86) PCT No.: PCT/EP2010/057153

§ 371 Date: Nov. 23, 2011

(30) Foreign Application Priority Data
May 26, 2009 (DE) 10 2009 022 716.4

(51) Int. Cl. G06Q 90/00; G08B 13/14; G05B 19/00

(52) U.S. Cl. 705/500; 340/5.8; 340/568.1

(57) ABSTRACT

A method relates to theft protection during a security check of carry-on luggage and/or other personal objects in passenger terminals of airports or the like. Objects are placed by the passenger in a provided container before the personal inspection of the passenger and are transported in the container for x-raying by a screening device, on the output side of which the container is provided after the personal inspection of the passenger for removal of the objects of the passenger that have been recognized as unsuspicious. In order to create theft protection during the security check of carry-on luggage if the personal objects of the passenger are still unattended in the containers after passing through the screening device, the container can be locked with a lock before the screening.

The invention relates to theft protection during the security check of carry-on luggage and/or other personal items in passenger terminals of airports or the like, during which the smaller items are placed by the passenger into a container before his personal inspection and are transported in said container for X-raying by a screening device, on the output side of which the container is provided, after the personal inspection of the passenger, for the removal of his items which have been identified as unsuspicious.

During carry-on luggage screening at airports, the airline passenger must nowadays place particular smaller items, such as notebooks, wallets, belts, watches, etc., onto a tray separately from the carry-on luggage, which tray is then transported on the conveying device through the screening device and is examined there, while the passenger passes through a metal detector in a parallel manner. The two processes which take place in a parallel manner in terms of time generally cannot be so well synchronized that the passenger is at the conveying device again before the arrival of the tray and can immediately take charge of his personal items again. It is very often the case that the tray has finished being examined before the passenger and is then unattended at the end of the conveying device until the passenger arrives there. The opportunity to steal personal items is available to thieves during this period of time. This phenomenon has been increasingly observed recently.

The object of the invention is to provide theft protection during the security check of carry-on luggage when the passenger's personal items are still unintended, after passing through the screening device, in the containers with which they have passed through the screening device.

In order to achieve the object, it is proposed that the container can be locked with a lock before screening. This advantageously makes it possible to prevent access by an unauthorized person at least during the personal inspection.

One preferred embodiment of the invention proposes that the key for the lock is worn by the passenger on his body during the personal inspection. This proposal makes it possible for only the authorized passenger to gain access to his items in the container, that is to say access by unauthorized persons is prevented or at least made difficult. Since the passenger wears the key, which is used by the passenger to close the container before screening, on his body, while he himself undergoes the security inspection, unauthorized reaching into the container with the personal items at least cannot take place unnoticed. The passenger can rest assured that his items are safe while he must undergo the personal inspection.

It is also advantageous if the passenger can lock and/or unlock the container using a key assigned to the lock. As a result, the passenger can lock or unlock the container on his own initiative and can lock or unlock the container at a time selected by him before or after the personal inspection without a member of staff involved in the security check having to participate in the locking and/or unlocking process.

Security can be increased further if a member of staff involved in the security check is able to use a control device to change a state of the lock and/or of a key assigned to the lock. A “state” of the lock can correspond to the unlocked and/or locked state, the member of staff himself unlocking or locking the container using the control device which, in this case, preferably corresponds to a key assigned to the lock. A “state” of the lock and/or of a key assigned to the lock can also be understood as meaning a configuration of the lock or of the key which can be selected using the control device and makes it possible for the passenger to operate the lock using the key or prevents the passenger from doing so. The lock and/or the key can thus be released for this operation using the control device and/or can be locked in order to prevent operation by the passenger. This makes it possible for the member of staff to determine the time at which the container may be locked and/or unlocked by the passenger. In this context, it is proposed, in particular, that the member of staff uses the control device to release the container for the removal of the items by the passenger after the personal inspection. This makes it possible, in particular, to prevent the premature removal of items by the passenger which have to undergo a further check by the member of staff, or removal can be prevented when particular events occur, for example in the event of a triggered security alarm or an emergency situation. In this case, release with the unlocking of the container can be carried out by the member of staff, or the member of staff can use the control device to change the state of the lock and/or of a key assigned to the lock so that the lock can be operated by the passenger using the key in order to independently unlock the container.

The invention allows a particular degree of security if a preferred proposal provides for a programmable and readable RFID lock which can be closed and opened using an electronic key to be provided for the purpose of locking the container. In contrast to a purely mechanical lock in which only one key fits into a lock, the RFID lock affords the advantage that an electronic key in the form of an RFID tag from a totality of keys can be freely combined with any electronic lock in the form of an RFID reading/writing device from a totality of locks. Such systems are already in commercial use nowadays, for example as locks for lockers in swimming pools or for doors in hotels.

In an alternative refinement of the invention, an optical or biometric key may also be possible, the former in the form of a barcode, for example, and the latter in the form of the passenger's fingerprint, for instance.

In one variant of the invention, the container is in the form of a box which can be closed on all sides. The passenger packs his personal items into the box, which, for example, consists of plastic with a lid which can be closed by the lock, and closes the box using an electronic RFID key. At the end of the conveying device, after screening, the closed box waits for the passenger and can be opened by the passenger and only by him using the RFID key which has been worn by the passenger on his body during the security examination.

According to the invention, unauthorized complete removal of the container can be detected using identification or localization techniques and can be indicated by raising an alarm and/or by means of a video system. If an unauthorized person takes the container with its contents from the conveying technology before the electronic lock has been unlocked, an alarm sounds, for example, and/or a video camera records the events happening around the container. For this purpose, the system is informed of whether the container is in the closed or open state. According to the invention, this can be effected by the electronic lock also being designed, in addition to reading from and writing to the RFID key, to emit an item of status information in the form of a radio or light signal to a corresponding sensor. According to the invention, such a sensor may be part of a conveying device for transporting the container.

However, it is also possible, within the scope of the invention, to design the container as an open receptacle, for example in the form of a conventional tray, and to prevent unauthorized access in another manner.

In order to also present theft protection for open receptacles, a favorable feature of the invention provides for the electronically closed receptacle to be monitored by video. The process takes place in exactly the same manner as the variant with closed containers but with the difference that the open receptacle which is still “locked” at the end of the conveying device is additionally monitored using a video system which monitors the receptacle for unauthorized access to the items in the receptacle and accordingly sounds an alarm if access is effected without previously “unlocking” the receptacle, that is to say the lock. In this case, the status information relating to the receptacle (closed/open) can be advantageously provided by means of a light signal according to the invention and can be directly evaluated by the video system.

Like in conventional systems without theft protection, the receptacles are preferably used as “circulating means”. In this case, both the boxes or trays with the lock and the keys circulate locally in the region of the carry-on luggage screening. Only a relatively small number of receptacles and keys are required for this purpose, as a result of which the investment costs and the storage space can be kept low.

The use of “passage means” is naturally also conceivable within the scope of the invention. In this case, the passenger would bring the receptacle and the RFID key and would also take them away again. This would have the advantage for the passenger (and the system operator) that the preparatory and follow-up activities for carry-on luggage screening could take place in a manner decoupled from the system. For the passenger, the entire process takes place in a more relaxed atmosphere and there is the potential to increase the system throughput.

However, this effect could also be achieved with the principle of circulating means by a different process configuration. Any desired combinations of circulating and passage means are also conceivable, for example bringing the tray to the carry-on luggage screening but leaving the tray there after examination has been carried out.

The particular advantage of the invention lies in the effective protection of the airline passenger from theft of personal items during carry-on luggage screening when the passenger, as a result of his own safety inspections, is not able to watch and monitor or is distracted from watching and monitoring his personal items.

One exemplary embodiment of the invention is illustrated in the drawing and is described below.

In the drawing

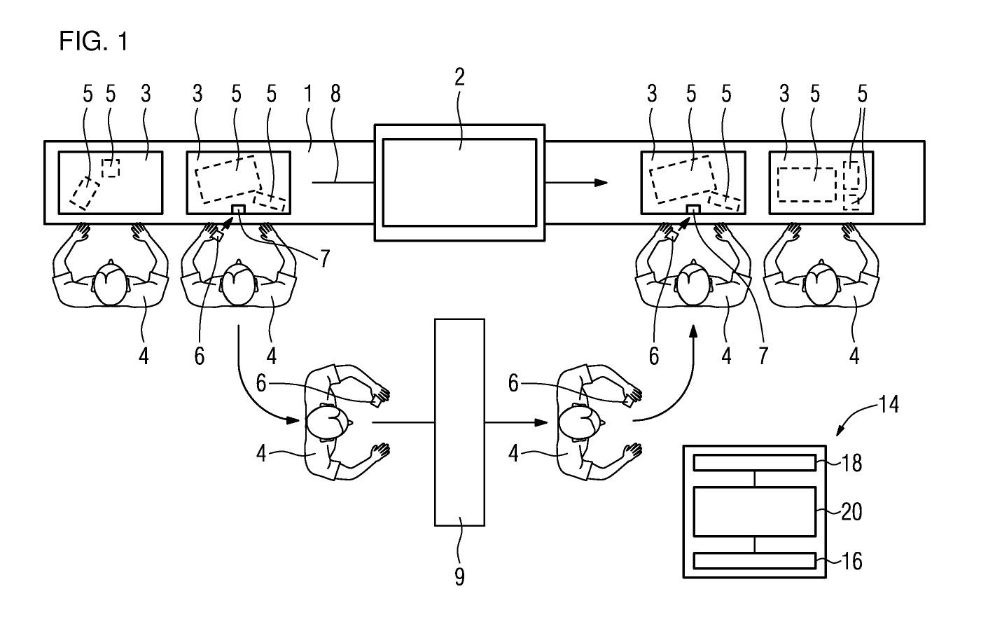

FIG. 1 shows the theft protection during the carry-on luggage screening of a closeable box,

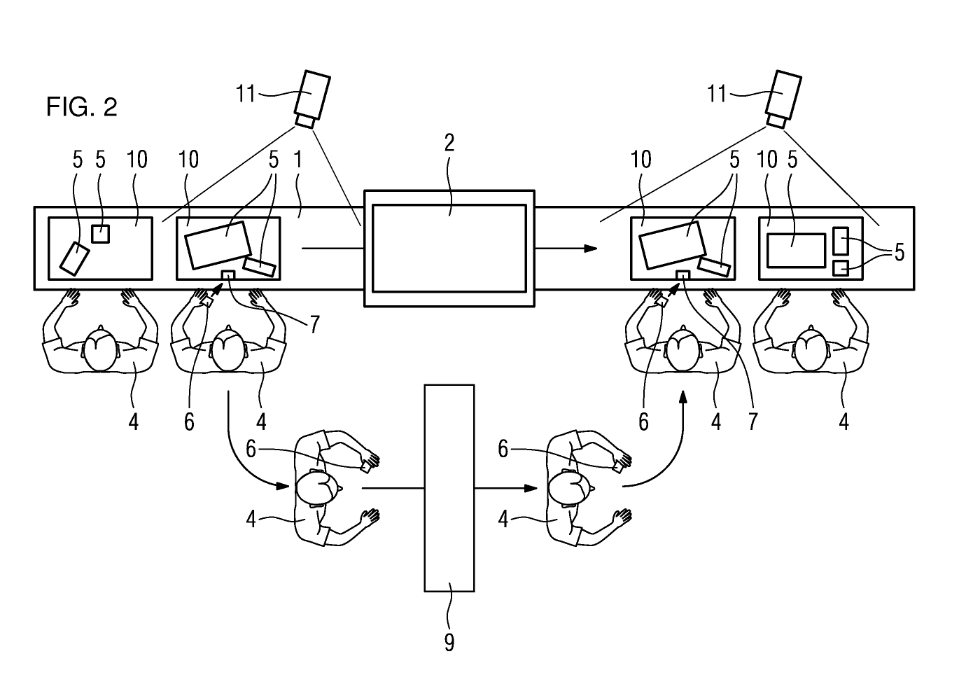

FIG. 2 shows the theft protection during the carry-on luggage screening of an open tray,

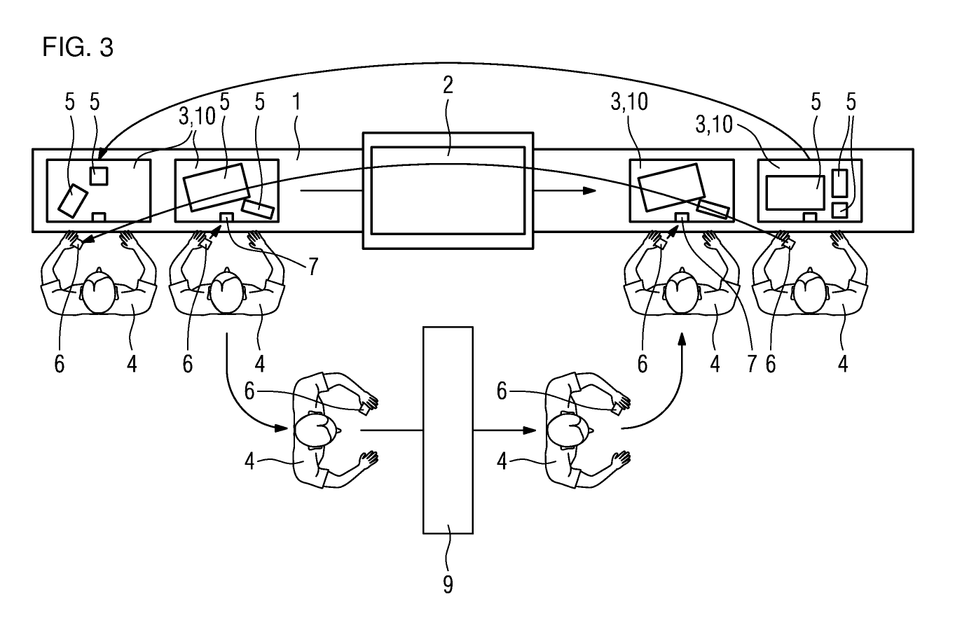

FIG. 3 shows the box or tray according to the invention as a circulating means, and

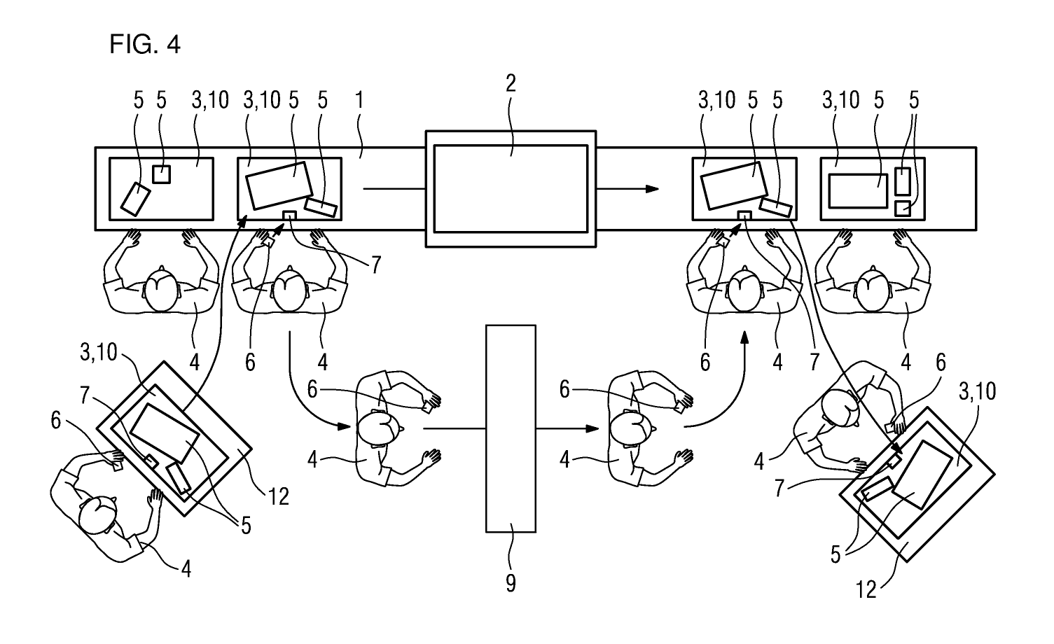

FIG. 4 shows the box and the tray according to the invention as passage means.

FIG. 1 illustrates a roughly diagrammatic illustration of a plan view of the security check area of an airport. 1 is used to denote a conveyor which is guided in a known manner through a screening device 2 (an X-ray device) and on which the boxes 3 lying on the conveyor 1 are transported from the left-hand (in the drawing) side of the screening device 2 to the right-hand side of the screening device 2. In this illustration, the boxes 3 are in the form of closed plastic receptacles with a lid into which the passenger symbolized with 4 places his personal items 5. After the lid of the box 3 has been closed, the passenger 4 locks the RFID lock 7 on the box 3 using an RFID key 6 and locks the box against unauthorized opening. The box 3 is transported through the screening device 2 in the direction of the arrow 8, is X-rayed and is possibly checked by the security staff for suspicious items. On the output side of the screening device 2 (that is to say on the right in the drawing), the boxes 3 are stopped on the conveyor 1 and wait for the passenger 4 there. The passenger has, in the meantime, passed through the metal detector 9 together with his RFID key 6 and passes to the other side of the screening device 2 where his box 3 containing his personal items 5 is waiting. He opens the box 3 using the RFID key 6 which he has worn on his body and removes the items 5 contained in the box without an unauthorized person having had the opportunity to reach the items 5.

FIG. 2 illustrates the same system using the example of open trays 10. In this case, the passenger 4 has placed his personal items 5 into the tray 10 which is provided on the conveyor 1 upstream of the screening device 2. The passenger 4 uses an RFID key 6 to “lock” the tray for unauthorized access operations and in the process activates the video system 11 which monitors the respective tray 10. The video system 11 can be activated, for example, by means of radio/light signals which are emitted by a corresponding sensor (not illustrated).

Like in the example in FIG. 1, the passenger 4 then proceeds to the personal inspection and passes, together with the RFID key 6, through the metal detector 9 into the security area. On the other side of the metal detector 9, the passenger 4 moves to his tray 10 and “unlocks” the tray 10 using his RFID key 6. As long as the tray 10 was locked, the video system 11 monitors the tray 10 for unauthorized access and possibly sounds an alarm if an unauthorized person tampers with the tray 10. The RFID lock 7 is “deactivated” only after the tray 10 has been unlocked using the RFID key 6, and the authorized passenger 4 who has carried out the unlocking process using the correct RFID key 6 only has access to his personal items 5.

FIG. 3 symbolically illustrates how a box 3 or a tray 10 is used as circulating means. As illustrated in FIGS. 1 and 2, the passenger 4 has locked the box 3 or the tray 10 with the aid of the RFID key 6 and now passes, together with the RFID key 6, through the metal detector 9 to the personal inspection. On the other side of the metal detector 9, the passenger 4 unlocks the RFID lock 7 on the box 3 or the tray 10 with the aid of the RFID key 6 and returns the RFID key 6 and the box 3 or the tray 10 with the RFID lock 7 and possibly the RFID key 6 to the other side of the screening device 2 for reuse. This circulation corresponds to the circulation of the known trays which are nowadays used without theft protection.

FIG. 4 illustrates a variant in which the box 3 or the tray 10 with the RFID lock 7 and the RFID key 6 are used as passage means. The passenger 4 arrives at the conveyor belt 1 already with a tray 10 or a box 3 in or on which his personal items 5 are situated and places the tray 10 or the box 3 onto the conveyor belt 1. In this case too, the passenger locks the box 3 or the tray 10 with the aid of his RFID key 6 and proceeds through the metal detector 9 to the personal inspection. On the other side of the metal detector 9, he unlocks the receptacle using the RFID key 6 carried on his body and removes said receptacle from the conveyor 1. He can leave the security check area with the container, the lock and the RFID key using a luggage cart 12 without an alarm signal sounding, as would happen in the event of unauthorized removal of the container.

A further embodiment variant of the security check area is explained with reference to FIG. 1. In this embodiment, a control device 14 which is intended for exclusive operation by the security check staff is provided. The control device 14 illustrated in FIG. 1 is optional and corresponds to an advantageous embodiment variant of the invention, an embodiment without a control device 14 being possible, as described above. The control device 14 has an input and output unit 16 which is used for operation of the control device 14 by the staff, at least one communication means 18 which is intended to establish a wireless data link to the respective lock 7 of the containers 3 and/or to the key 6 assigned to this lock 7, and a control unit 20 which controls the operations with the input and output unit 16 and the communication means 18 and is operatively connected to them for this purpose.

The security check staff can change a state of the lock 7 and/or of the key 6 assigned to the lock 7 with regard to a particular container 3 with the aid of the control device 14. After the container 3 has been locked by the passenger using the key 6, the lock 7 and/or the key 6 is/are changed to a state in which it is impossible to operate the lock 7 with the aid of the key 6. This is effected by the security check staff using the control device 14 which transmits control data to the lock 7 or the key 6. The lock 7 or the key 6 is in a locked state in this case. After the personal inspection has been carried out, the container 3 can be unlocked by the passenger only after the staff has changed the state of the lock 7 or of the key 6 using the control device 14 and the lock 7 and/or the key is/are in a released state in which it is possible to operate the lock 7 using the key 6. If it is necessary to examine the container 3 further, premature removal of the items 5 by the passenger can be prevented hereby. If no further examination is necessary, the staff releases the container 3, with the aid of the control device 14, for removal of the items 5 by the passenger.

In another embodiment variant, it is conceivable for the staff to lock and/or unlock the container 3 using the control device 14 and/or using the key 6.

1-15. (canceled)

16. A method of providing theft protection during a security check of carry-on luggage or other personal items in passenger terminals of airports, which comprises the steps of:
placing items, by a passenger, into a provided container before a personal inspection of the passenger;
locking the container with a lock before a screening process is performed;
transporting the container to X-raying by a screening device; and
transporting the containing to an output side after the personal inspection of the passenger, for removal of the items which have been identified as unsuspicious.

17. The method of theft protection according to claim 16, wherein a key for the lock is worn by the passenger on his body during the personal inspection of the passenger.

18. The method of theft protection according to claim 16, wherein the passenger locks and unlocks the container using a key assigned to the lock.

19. The method of theft protection according to claim 16, wherein a member of staff involved in a security check uses a control device to change a state of the lock and/or of a key assigned to the lock.

20. The method of theft protection according to claim 19, wherein the member of staff uses the control device to release the container for the removal of the items by the passenger after the personal inspection of the passenger.

21. The method of theft protection according to claim 16, which further comprises providing a programmable and readable RFID lock which can be closed and opened using an electronic key as the lock for locking the container.

22. The method of theft protection according to claim 16, which further comprises providing an electronic lock which can be opened using an optical or biometric key as the lock for locking the container.

23. The method of theft protection according to claim 16, which further comprises providing a box as the container which can be closed on all sides.

24. The method of theft protection according to claim 16, wherein the container is in a form of an open receptacle.

25. The method of theft protection according to claim 16, which further comprises detecting unauthorized removal of the container using identification or localization techniques and can be indicated by raising an alarm and/or by means of a video system.

26. The method of theft protection according to claim 22, which further comprises designing the electronic lock to emit an item of status information in a form of a radio signal or light signal to a corresponding sensor.

27. The method of theft protection according to claim 26, wherein the corresponding sensor is part of a conveying device for transporting the container.

28. The method of theft protection according to claim 24, which further comprises monitoring an electronically closed receptacle using a video system.

29. The method of theft protection according to claim 26, which further comprises emitting the status information to the video system for evaluation by means of a light signal.

30. The method of theft protection according to claim 17, which further comprises providing the container with the lock and the key in a form of circulating means in a region of the security check.
